(19) United States
(12) Patent Application Publication
(10) Pub. No.: US 2025/0230317 A1
(43) Pub. Date: Jul. 17, 2025

(54) BITUMEN PELLETS AND METHOD OF PRODUCING

(71) Applicant: ARCISHMAAN ELEMENTS PRIVATE LIMITED, Coimbatore (IN)

(72) Inventor: Chakravarthy SAMPATH NARAYANAN, Coimbatore (IN)

(21) Appl. No.: 18/854,595

(22) PCT Filed: Mar. 30, 2023
(86) PCT No.: PCT/IN2023/050318

§ 371 Date: Oct. 7, 2024

(30) Foreign Application Priority Data
Apr. 14, 2022 (IN) 202241022246

(51) Int. Cl. C08L 95/00; C04B 24/36; C08K 3/36

(52) U.S. Cl. CPC C08L 95/00; C04B 24/36; C08K 3/36

(57) ABSTRACT

The present invention provides bitumen pellets and method of producing, and a method of using the bitumen pellets for laying a carpet on a surface, such as road laying, and a mixture comprising the bitumen pellets of the present invention.

### CROSS-REFERENCE

The present application claims priority from the INDIAN (IN) Patent Application numbered 202241022246, dated 14 Apr. 2022 filed with the provisional patent specification.

### TECHNICAL FIELD OF THE INVENTION

Firstly, the present invention is not for the purpose of defence.

The present invention relates to bitumen pellets and method of producing.

In one of the embodiments, the present invention relates to a method of using the bitumen pellets of the present invention for laying a carpet on a surface, such as construction of road and highways.

In another embodiment, the present invention relates to a mixture comprising the bitumen pellets of the present invention.

### BACKGROUND OF THE INVENTION

For development of a country, construction of roads and highways is essential so that transportation is made easy. The construction of road is a challenging task because first aim is to avoid or at least minimize air pollution while constructing a road, and the road so constructed should be suitable to bear load and burden of traffic as well as of changing environment. At the same time, aim is also to reduce or minimize dependency on sophisticated machinery, because in rural areas, remote areas, villages, hilly areas, and so on availability of sophisticated machinery is generally not possible. Furthermore, aim is also to reduce or minimize cost of construction of road.

The essential component for construction of roads is bitumen. The bitumen is primarily produced in petroleum refineries and it is transported from the refineries and made available either in bulk or in drums. It may also be referred to as ‘road bitumen’.

In order to avoid or at least minimize air pollution while constructing a road, the bitumen or bitumen mixture is transported to the site of construction of road in ‘a pre-mixed form’.

In order to construct a road suitable to bear load and burden of traffic as well as of changing environment, the bitumen-based road must be able to withstand the load and burden of traffic as well as of changing environment, for example, cold and hot environment, and wet and dry environment.

In order to reduce or minimize dependency on sophisticated machinery, so that the roads can also be constructed in rural areas, remote areas, villages, hilly areas, and so on, the bitumen or bitumen mixture should be suitable to be ‘stored’ and ‘transported’ in an ordinary truck, container, etc. The ‘bitumen storage’ and ‘transportation of bitumen’ are the main current challenges faced by the industry. Additionally, ‘safety’, i.e., avoiding inherent hazards in handling heated products storage and transportation is also a concern of the industry. Additionally, avoiding ‘energy loss’ and ‘CO₂ footprint’ are also a concern of the industry.

In order to reduce or minimize the cost of construction of road, the bitumen or bitumen mixture should be suitable to be stored and transported in an ordinary truck, container, etc. which should not require sophisticated storing and/or transporting and/or heating arrangements, such as trucks or containers having heating facility to maintain the bitumen or bitumen mixture at a temperature of about 70° C. to 145° C. during storage and transportation, i.e., bulk heated trucks or heated pipelines, and in case of sea transport in specialized heated bitumen tanks to transport from one place to another supported by heated pipelines to receive and discharge at the port jetties. Even if the bitumen is transported at a low temperature, i.e., a temperature lower than 90° C., i.e., at a temperature of about 30° C. to 90° C., depending upon the environment temperature, it still requires steel drums which are typically expensive, which not only adds to environment pollution, but also adds to costs of construction of roads and highways.

More importantly, to meet the requirements of construction of road in cold and hot region, and in wet and dry region, the bitumen or bitumen mixture should be storable and transportable during all possible weather.

As discussed herein above, the current state of the bitumen or the bitumen mixture supply chain faces one or more of the following technical problems:
(1) Storage: The bitumen storage requires fixed roof tanks with heating facility which are capex intensive to build and it takes few months to a year to build and commission for such a storage facility.
(2) Transport: The bitumen or bitumen mixture requires specialized heated trucks or ships or heated pipeline or expensive steel drums for transporting the bitumen or bitumen mixture.
(3) Safety: The process of bitumen handling is inherently challenging with respect to its process of preparation, storage and transportation; and personal safety considering bitumen is maintained at a very high temperature throughout the supply chain.
(4) Energy and CO₂ footprint: Since the bitumen or bitumen mixture needs to be kept hot throughout the supply chain, it needs a continuous supply of heat to maintain the required temperature which involves energy consumption leading to larger CO₂ footprint during its storage and transportation.
(5) Bitumen Availability: Bitumen is a seasonal product with low demand during rainy season.
(6) Bitumen Plant Utilization: Since the demand of bitumen is low during rainy season, the bitumen plant in the refinery will be forced to shut-down resulting in low utilization of the plant.

Therefore, to meet the above requirements and to avoid the above-discussed technical problems, one would require a bitumen or a road bitumen, or a bitumen mixture which should satisfy all or at least majority of the above-discussed requirements of the bitumen or the road bitumen, or the bitumen mixture, and overcome all or at least majority of the above-discussed technical problems of the bitumen or the road bitumen or the bitumen mixture, and such bitumen or road bitumen, or bitumen mixture may be referred to as an ideal bitumen or ideal road bitumen, or ideal bitumen mixture.

The available art does not provide such an ideal bitumen or ideal road bitumen, or ideal bitumen mixture.

### NEED OF THE INVENTION

Therefore, it is desirable to provide an ideal bitumen or an ideal road bitumen, and to provide a mixture comprising the same, and to provide a method of preparation thereof, and to provide a method of using the same for laying a carpet on a surface, such as road laying.

### PROBLEM TO BE SOLVED BY THE INVENTION

Accordingly, main aim of the present invention is to solve all or at least majority of the above-discussed technical problems of storage and transportation of the bitumen or the road bitumen or the bitumen mixture by providing the novel and improved bitumen or road bitumen or mixture thereof, and a method of producing the same, and a method of using the same for laying a carpet on a surface, such as road laying, and the bitumen or the road bitumen or the bitumen mixture so provided should also meet all or at least majority of the above-discussed requirements.

### OBJECTS OF THE INVENTION

Therefore, main object of the present invention is to provide a novel and improved bitumen or road bitumen or a mixture thereof, and a method of producing the same, and a method of using the same for laying a carpet on a surface, such as road laying, wherein the bitumen is converted to bitumen pellets, which may also be referred to as bitumen pellet composition, which are capable of being stored at a room temperature and are also capable of being transported at a room temperature in a pre-mixed form to a desired site or a location without requiring or using a sophisticated arrangement, such as bulk heated trucks or heated pipelines, or specialized ships, or expensive steel drums, that is, wherein the bitumen pellets or the bitumen pellet composition, or mixtures thereof would not require a heating facility.

Accordingly, another object of the present invention is to provide the bitumen pellets or the bitumen pellet composition which is capable of avoiding or at least minimizing air pollution while constructing a road, because the bitumen pellets or the bitumen pellet composition of the present invention is capable of being provided in a pre-mixed form requiring no heating arrangements during storage and transportation to desired site or location.

Accordingly, still another object of the present invention is to provide the bitumen pellets or the bitumen pellet composition which is suitable to construct a road capable of bearing a load and a burden of traffic as well as of changing environment, for example, cold and hot environment, and wet and dry environment.

Accordingly, yet another object of the present invention is to provide the bitumen pellets or the bitumen pellet composition which is capable of avoiding dependency on sophisticated machinery, hence is suitable for constructing the roads or even the highways even in the rural areas, the remote areas, the villages, the hilly areas, and so on.

Accordingly, yet another object of the present invention is to provide the bitumen pellets or the bitumen pellet composition which is capable of reducing or at least minimizing the cost of construction of a road or a highway.

Accordingly, yet another object of the present invention is to provide the bitumen pellets or the bitumen pellet composition which is suitable to be stored and transported in an ordinary truck, container, etc., hence which is suitable for transporting without requiring sophisticated storing and/or transporting and/or heating arrangements, such as trucks or containers having heating facility to maintain the bitumen or bitumen mixture at a temperature of about 50° C. to 145° C., i.e. without requiring sophisticated bulk heated trucks or heated pipelines, and in case of sea transport without requiring sophisticated specialized heated bitumen tanks to transport from one place to another, and without requiring sophisticated heated pipelines to receive and discharge at the port jetties, and without requiring typically expensive steel drums.

Accordingly, yet another object of the present invention is to provide the bitumen pellets or the bitumen pellet composition which is suitable for storage and transportation during all possible weather, hence is suitable for construction of road and highway in cold and hot regions, and in wet and dry regions.

It may be noted that the terms “bitumen”, “road bitumen” and “bitumen mixture” may be used interchangeably, and the term “bitumen pellet” or the term “bitumen pellets”, or the term “bitumen pellet composition”, or the term “mixture of bitumen pellets” are intended to define the “bitumen product” of the present invention.

Further objects and advantages of the present invention would be more apparent from the following description of the invention.

### DESCRIPTION and EMBODIMENTS OF THE INVENTION

With aim to solve the above-discussed technical problems of the existing bitumen or road bitumen, and to provide novel and improved bitumen pellets or a bitumen pellet composition, the inventor has found that if the bitumen is combined with:
a) polyvinyl alcohol (PVA);
b) polyvinyl acetate (PVAc); and
c) anti-agglomeration agent (AAA),
   then the resulted composition, which may also be referred to as bitumen pellet composition, surprisingly and unexpectedly, was found to be:
(i) Capable of being stored at a room temperature and capable of being transported at a room temperature in a pre-mixed form to a desired site or a location without requiring or using a sophisticated arrangement, such as bulk heated truck, heated pipeline, specialized ship, or expensive steel drum, that is, without requiring a heating facility;
(ii) Capable of avoiding or at least minimizing air pollution while constructing a road or a highway, because the bitumen pellet composition has been found to be suitable of being transported and used in a pre-mixed form requiring no heating arrangements during storage and transportation to desired site or location;
(iii) Suitable to construct a road or a highway capable of bearing a load and a burden of traffic as well as of changing environment, including but not limited to cold environment, hot environment, wet environment, and dry environment;
(iv) Capable of avoiding dependency on sophisticated machinery, hence has been found to be suitable for constructing road and even highway even in the rural area, the remote area, the villages, the hilly area, and so on, which is a need of country, like India;
(v) Capable of reducing or at least minimizing the cost of construction of a road or a highway, because the processing of preparing the bitumen pellet composition is simple, and its storage and transportation does not require sophisticated arrangements;
(vi) Suitable to be stored and transported in an ordinary truck, container, bag, or box, etc., which eliminates the expensive and challenging supply chain, hence has been found to be suitable for transporting without requiring sophisticated storing and/or transporting and/or heating arrangements including but not limited to bulk heated truck, heated pipeline, heated tank, or expensive steel drums;
(vii) Suitable for substantially minimizing costs of construction of road and highway;
(viii) Suitable to have green and clean environment, and low energy consumption without wastage of the energy in heating the bitumen pellets during storage and transportation, hence lower energy cost; and
(ix) Suitable for storage and transportation during all possible weather, hence has been found to be suitable for construction of road and highway in cold and hot regions, and in wet and dry regions.

Accordingly, in first embodiment, the present invention relates to a novel and improved bitumen pellet composition, wherein the composition essentially consists of: bitumen combined with:
a) polyvinyl alcohol (PVA);
b) polyvinyl acetate (PVAc); and c)1 anti-agglomeration agent (AAA).

In accordance with one of the preferred embodiments of the present invention, the anti-agglomeration agent (AAA) is essentially a fumed silica, wherein the fumed silica is essentially hydrophilic fumed silica.

In accordance with one of the preferred embodiments of the present invention, the bitumen pellet composition essentially consists of:
(a) bitumen as base binder;
(b) polyvinyl alcohol (PVA);
(c) polyvinyl acetate (PVAc); and
(d) anti-agglomeration agent (AAA),
   wherein the anti-agglomeration agent (AAA) is essentially a fumed silica; and wherein the fumed silica is essentially hydrophilic fumed silica.

In accordance with one of the preferred embodiments of the present invention, the bitumen pellet composition essentially comprises (a) the bitumen, wherein the bitumen is taken in an amount varying from about 91% to about 98% by wt. relative to the total weight of said bitumen pellet composition.

In accordance with one of the preferred embodiments of the present invention, the bitumen pellet composition essentially comprises (b) polyvinyl alcohol (PVA), wherein the PVA is taken in an amount varying up to about 2% by wt. relative to the total weight of said bitumen pellet composition.

In accordance with one of the preferred embodiments of the present invention, the bitumen pellet composition essentially comprises (c) polyvinyl acetate (PVAc), wherein the PVAc is taken in an amount varying up to about 5% by wt. relative to the total weight of said bitumen pellet composition.

In accordance with one of the preferred embodiments of the present invention, the bitumen pellet composition essentially comprises (d) anti-agglomeration agent (AAA), wherein the AAA is taken in an amount varying up to about 2% by wt. relative to the total weight of said bitumen pellet composition.

In accordance with one of the embodiments of the present invention, the bitumen pellets of the present invention are covered by a thin and sturdy outer layer of the above-said components (b), (c) and (d) of the present invention, so as to achieve an advantage of avoiding the bitumen pellets getting spillover during transportation, hence the bitumen pellets of the present invention are stable, can be safely transported in a normal truck.

In accordance with one of the embodiments of the present invention, the PVA may be diluted with equal quantity of water and mixed before applying on bitumen pellets so as to have ease of coating the bitumen surface.

In accordance with one of the embodiments of the present invention, the PVAc may also be diluted with equal quantity of water and mixed before applying on bitumen pellets so as to have ease of coating the bitumen surface.

It has been found that the presently provided bitumen pellets or bitumen pellet composition has the advantage of ease of storage, handling and transportation compared to the traditional bitumen pellets which require high temperature and specially designed tanks and trucks to store and transport, hence need specialized expertise to produce, store and transport to meet the industry need.

Without being bound by the theory, ideally shape of the bitumen pellet employed is generally spherical, more rounded and smaller to ensure less material is used for coating or covering as well as reducing agglomeration and settling issues. However, other shapes and sizes, such as, cylindrical and irregular shape may also be used.

Without being bound by the theory, ideally for packaging of the bitumen pellets, these may be stored in closed containers to avoid spillage and moisture related issues, wherein the storage may be in square, rectangular or spherical containers or bags.

Without being bound by the theory, ideally the height of the storage container may be selected in such a way that the reduction in height or volume is not more than about 15% due to one or more issues such as vibration, compaction, settling due to gravity or other issues. The ideal height may be selected as per storage temperature, bulk density of bitumen pellets, shape of containers, and many more.

Bitumen pellets containers may be placed over one another but care should be taken to ensure the weight of above tray or bag/container is not translated to the below bags or containers.

Stored Bitumen pellets in the bottom layer may need gentle efforts to remove from the container. Typically, silicone rubber sheets are used to prevent the bitumen pellets from sticking in the containers. Alternatively, ethyl vinyl acetate (EVA) coatings or bags placed in a container prevents stickiness to the walls of the container.

It may be noted that one may add tyre rubber, crumb rubber, or reclaimed tyre rubber in the presently provided bitumen pellet composition. However, such a resulted composition would require heating to a temperature of about 176.67° C. (350° F.) or above for a longer duration (period). Therefore, the addition of the tyre rubber, the crumb rubber, or the reclaimed tyre rubber in the presently provided bitumen pellet composition would:
Require a significant amount of energy;
Generate a significant amount of waste and pollution having negative impact on the environment, hence would be environmentally hazardous and adversely affect health of the workers;
Result in increase of cost;
Have compatibility issues, such as, the crumb rubber may have a negative impact on the viscosity of the bitumen, which can affect the performance of the asphalt;
Have health concerns, as the exposure to crumb rubber may be associated with an increased risk of certain health problems, including cancer;
Have durability concern, as crumb rubber in asphalt may not be as durable as traditional asphalt, which could lead to a shorter lifespan for the pavement.

Therefore, in accordance with one of the embodiments of the present invention, the bitumen pellet composition of the present invention does not comprise tyre rubber, crumb rubber, or reclaimed tyre rubber in any form, hence the process to prepare the bitumen pellet composition of the present invention is simple and does not require a step of heating the mixed components of the present composition, and therefore, it avoids the above-discussed problems associated with the tyre rubber, the crumb rubber, and the reclaimed tyre rubber.

It may also be noted that one may add lime or lime-based product(s) in the presently provided bitumen pellet composition may be as a coat to the resulted bitumen pellets, however, such a resulted composition would not only require a step of heating to a high temperature, but such a resulted composition has been found not suitable at a temperature above 25° C. Therefore, the addition of the lime or lime-based product(s) in the presently provided bitumen pellet composition would result in:
1. increased viscosity, which would impact the bitumen implied specification to be certified as pure bitumen, and may make the bitumen thicker, hence making it more difficult to work with and apply to surfaces;
2. reduced flexibility, that is the resulted bitumen pellets would be less flexible, which can lead to cracking and breaking in the asphalt;
3. reduced adhesion to a surface, which can lead to poor bonding and reduced durability;
4. increased cost;
5. environmental issues, such as negative effect on the environment if not handled and used properly.

Therefore, in accordance with one of the embodiments of the present invention, the bitumen pellet composition of the present invention does not comprise or uses lime or lime-based product(s) including limestone may be as a coat to the bitumen pellets, which avoids the need to heat limestone to a very high temperature, hence it again avoids environmental hazards and adverse effects on health of the workers.

In accordance with one of the embodiments of the present invention, the bitumen pellet composition may be prepared by any method known in the art by mixing its ingredients in any order. Therefore, the scope of the present invention is not intended to be limited to a method of preparation of the presently provided bitumen pellet composition.

However, in accordance with one of the exemplary embodiments, the bitumen pellet composition of the present invention may be prepared by comprising the following steps:
a) a step of providing a layer or a coating of hydrophilic fumed silica over the bitumen;
b) a step of providing a layer or a coating of polyvinyl alcohol (PVA);
c) a step of drying the bitumen pellet coated with the hydrophilic fumed silica in step a), the polyvinyl alcohol (PVA) in step b);
d) a step of providing a layer or a coating of polyvinyl acetate (PVAc) on the coated bitumen pellet obtained in step c);
e) a step of drying the bitumen pellet as obtained in step d) after coating with the hydrophilic fumed silica in step a), the polyvinyl alcohol (PVA) in step b), and polyvinyl acetate (PVAc) in step d); and
f) a step of providing a thin layer or a coating of hydrophilic fumed silica over the bitumen pellet as obtained in step e); and
g) optionally a step of drying the bitumen pellet as obtained in step f).

It has been found that the step of providing a layer or a coating of the hydrophilic fumed silica over the bitumen has been found to have an advantage of avoiding the bitumen pellets of the present invention getting spillover during transportation, hence the bitumen pellets of the present invention are stable, can be safely transported in a normal truck. Therefore, the optional step g) of heating is generally performed at the destination which has been found to advantage of having the bitumen pellets of the present invention separable from each other if the need be.

It has also been found that the step of providing a layer or a coating of polyvinyl alcohol (PVA) has been found to have an advantage of keeping the bitumen pellets separated from each other.

It may be noted that the above-said steps of the presently provided method of preparation of the bitumen pellets or the bitumen pellet composition of the present invention may be carried-out in any order, however, if the bitumen is coated first with the hydrophilic fumed silica, followed by coating with the polyvinyl alcohol (PVA) and with the polyvinyl acetate (PVAc) [in the alternate embodiment followed by coating with the polyvinyl acetate (PVAc) and with the polyvinyl alcohol (PVA)], and finally again with the hydrophilic fumed silica, then the resulted bitumen pellets or the bitumen pellet composition has been found to be best suitable for the intended purposes.

Accordingly, in one embodiment, the present invention also relates to a method of using the bitumen pellets of the present invention for laying a carpet on a surface, such as construction of road and highways.

Accordingly, in one embodiment, the present invention also relates to a mixture comprising the bitumen pellets of the present invention.

In accordance with one of the embodiments of the present invention, the bitumen pellet composition may be tested for its characteristics by any method known in the art. Therefore, the scope of the present invention is not intended to be limited to a method of testing characteristics of the presently provided bitumen pellet composition.

However, in accordance with one of the exemplary embodiments, the bitumen pellets or the bitumen pellet composition of the present invention may be tested by one or more of the following testing methodologies:
(1) Device suitable to test the bitumen pellet composition to evaluate product storage and packaging for transport;
(2) Test for petroleum industry standards for bitumen and evaluate how the presently provided bitumen pellets or bitumen pellet composition performs in comparison to the bitumen without coating of the components (b), (c) and (d) of the present invention;
(3) Test for road industry standard for rheological properties of asphalt binder and evaluate how the presently provided bitumen pellets or bitumen pellet composition performs in comparison to the bitumen without coating of the components (b), (c) and (d) of the present invention.

Further embodiments and advantages of the present invention would be apparent from the following experimental discussion, which is not intended to limit scope of the present invention.

### Experiments

For the present tests, the bitumen used is a bitumen VG30 grade, and it is coated with:
About 1% by wt. of polyvinyl Alcohol (PVA);
About 2% by wt. of polyvinyl acetate (PVAc) monomer; and
About 1% by wt. of hydrophilic fumed silica as Anti-Agglomeration Agent (AAA) or About 1% by wt. of hydrophobic fumed silica.

Accordingly, in accordance with an exemplary embodiment, the presently provided bitumen pellet composition comprises:
About 96% by wt. of Bitumen coated or covered with a layer comprising:
About 1% by wt. of PolyVinyl Alcohol (PVA);
About 2% by wt. of Poly Vinyl Acetate (PVAc) Monomer; and
About 1% by wt. of Hydrophilic Fumed Silica as Anti-Agglomeration Agent (AAA).

It may be noted the components of the present invention, including bitumen of VG30 may be obtained from any source. For the present experiments, the bitumen VG30 grade was sourced from the Indian Oil Corporation Limited (IOCL); the polyvinyl alcohol (PVA) liquid was sourced from Astrra Chemicals (Code AC 177); the polyvinyl acetate (PVAc) monomer was sourced from Research Dye Chem Pvt. Ltd., (RECOTEX-9051), the hydrophilic fumed silica (CAB-O-SIL Grade: EH5) and the hydrophobic fumed silica (CAB-O-SIL Grade: TS-610) were sourced from Cabot Sanmar Limited, India.

The comparative bitumen compositions and the presently provided bitumen pellet composition were evaluated by one or more of the following tests.

### Test-1: Load Resistance Under Different Loading Conditions and Temperatures

As discussed herein, the key challenges faced by the industry producing and supplying the bitumen pellets are: the storage and the transportation. To evaluate performance of the bitumen pellets for these challenges, the bitumen pellets are subjected to a test which can assess their load resistance under different loading conditions and temperatures. The temperatures can be chosen such that they represent cold climate, normal room temperature, and hot climate.

As per one of the exemplary embodiments, the load resistance test utilizes a cylindrical transparent container (with top and bottom open) with a capacity to hold about 10 grams of pellets having a diameter of about 3.0 cm. The plate of the Rheometer having a diameter of about 2.5 cm that can travel from the top to the bottom of the cylindrical container at chosen velocity as well as hold at different heights, and applies force on the surface of the pellets. The bottom stage of the Rheometer can be used for temperature control. For this test, the Anton Paar Physica MCR 301 Rheometer is used to apply loads on samples in controlled stress or controlled strain (strain rate) condition.

As one of the exemplary embodiments, this test was performed as follows:
1. about 10 g of bitumen pellets were placed in a cylinder at the bottom stage of the rheometer (Anton Paar Physica MCR 301 Rheometer);
2. the cylinder is tapped gently 100 times, to allow pellet bed packing;
3. the rheometer plate is moved downwards by 1 mm (from the surface of the pellets) at a velocity of 1.667 micron per second to apply vertical load;
4. a constant load of 1N (downwards) is applied on the surface of the pellets for about three hours;
5. on completion of the test, the piston is withdrawn and the samples are removed and evaluated for appearance and their agglomeration;
6. test is carried out at four different temperatures: 10° C., 25° C., 40° C. and 45° C.; and
7. evaluation of the bitumen pellets is recorded on a five-level scale—excellent, very good, good, average, and poor, wherein
   a) the excellent performance means: complete separation of the bitumen pellets from one another with less or no efforts to separate. In general, about 95% or above bitumen pellets retain their shape;
   b) the very good performance means: Up to about 15% of the bitumen pellets cannot be separated from one another with efforts to separate. About 15% of the bitumen pellets lost their shape due to agglomeration and/or elongation;
   c) the good performance means: Up to about 25% of the bitumen pellets cannot be separated from one another with efforts to separate. About 25% of the bitumen pellets lost their shape due to agglomeration and/or elongation;
   d) the average means: Up to about 30% of the bitumen pellets cannot be separated from one another with efforts to separate. About 30% of the bitumen pellets lost their shape due to agglomeration and/or elongation; and
   e) the poor means: Up to about 35% of the bitumen pellets cannot be separated from one another with efforts to separate. About 35% of the bitumen pellets lost their shape due to agglomeration and/or elongation.

The experimental data is given in Table-I.

As can be observed from the data given in Table-I, only the presently provided bitumen pellet composition, surprisingly and unexpectedly, demonstrated the excellent performance at the different temperatures of 10°° C., 25° C., and 40° C. as compared to the comparative bitumen pellets.

TABLE I

| | Bitumen Pellet's | Evaluated | Evaluated | Evaluated | Evaluated | |
|---|---|---|---|---|---|---|
| Expt. No. | Composition | Level at 10° C. | Level at 25° C. | Level at 40° C. | Level at 45° C. | Comments |
| 1 | 99% by wt. Bitumen, | NA | NA | NA | NA | Complete |
| (Comparative) | and | | | | | Agglomeration within |
| | 1% by wt. of PVA | | | | | minutes, hence not |
| | | | | | | suitable for evaluation at |
| | | | | | | different temperatures. |
| 2a | 98% by wt. Bitumen, | Excellent | Average | Poor | NA | Since the results are |
| (Comparative) | 1% by wt. of PVA, and | | | | | poor at a temperature of |
| | 1% by wt. of | | | | | 40° C., no evaluation was |
| | hydrophobic fumed | | | | | performed at 45° C. |
| | silica as AAA | | | | | |
| 2b | 98% by wt. Bitumen, | Excellent | Very good | Poor | NA | Since the results are |
| (Comparative) | 1% by wt. of PVA, and | | | | | poor at a temperature of |
| | 1% by wt. of | | | | | 40° C., no evaluation was |
| | hydrophilic fumed | | | | | performed at 45° C. |
| | silica as AAA | | | | | |
| 3 | 98% by wt. Bitumen, | NA | NA | NA | NA | Complete |
| (Comparative) | and | | | | | Agglomeration within |
| | 2% by wt. of PVAc | | | | | minutes, hence not |
| | | | | | | suitable for evaluation at |
| | | | | | | different temperatures. |
| 4a | 97% by wt. Bitumen, | Excellent | Good | Poor | NA | Since the results are |
| (Comparative) | 2% by wt. of PVAc, | | | | | poor at a temperature of |
| | and | | | | | 40° C., no evaluation was |
| | 1% by wt. of | | | | | performed at 45° C. |
| | hydrophobic fumed | | | | | |
| | silica as AAA | | | | | |
| 4b | 97% by wt. Bitumen, | Excellent | Very Good | Average | NA | Since the results are |
| (Comparative) | 2% by wt. of PVAc, | | | | | average at a temperature |
| | and | | | | | of 40° C., no evaluation |
| | 1% by wt. of | | | | | was performed at 45° C. |
| | hydrophilic fumed | | | | | |
| | silica as AAA | | | | | |
| 5 | 96% by wt. Bitumen, | Excellent | Excellent | Poor | NA | Since the results are |
| (Comparative) | 1% by wt. of PVA, | | | | | poor at a temperature of |
| | 2% by wt. of PVAc, | | | | | 40° C., no evaluation was |
| | and | | | | | performed at 45° C. |
| | 1% by wt. of | | | | | |
| | hydrophobic fumed | | | | | |
| | silica as AAA | | | | | |
| 6 | 96% by wt. Bitumen, | Excellent | Excellent | Excellent | Very Good | Experiment No. 6 (the |
| (Present | 1% by wt. of PVA, | | | | | present composition) |
| Invention) | 2% by wt. of PVAc, | | | | | provides the best |
| | and | | | | | performance. |
| | 1% by wt. of | | | | | |
| | hydrophilic fumed | | | | | |
| | silica as AAA | | | | | |

### Test 2: Key Petroleum Standards Testing

In addition, the bitumen pellets are subjected to key petroleum standard testing for penetration test and softening point test. The results of bitumen (the base binder) and bitumen pellets (binder with modifier) are in comparable range thus indicating that the bitumen pellets meet similar key petroleum standards for the bitumen.

### Test 3: Penetration Efficiency

In addition, the bitumen pellets were also are subjected to penetration test as per IS73, 2013, and it was found that the penetration efficiency at 25° C., 100 g, 5 s, 0.1 mm of the presently provided bitumen pellet composition as of Test-1 was 37 against the penetration efficiency of 52 of the commercially available bitumen of grade VG30, which confirms that the penetration efficiency is substantially improved, because for the bitumen penetration, the lower value indicates better quality, as it implies a harder and more viscous material, and it will be more resistant to deformation and be more suitable for applications that require higher stability and durability, such as for highways.

### Test 4: Key Road Testing

Similarly, the samples are subjected to key road-testing standards. Rutting and Fatigue are the two major problems faced by the bitumen road laying industry. Rutting is a short- and medium-term phenomena whereas fatigue is longer term. Inherent characteristics of bitumen contribute to rutting and fatigue.

ASTM (American Standard of Testing Material) Standard D7175-15 is designed for determining the Rheological properties of the asphalt binder using a dynamic shear rheometer (DSR). This test method covers the determination of the dynamic shear modulus and phase angle of asphalt binders when tested in dynamic (oscillatory) shear using parallel plate geometry.

The results of the bitumen and the bitumen pellet composition for key road-testing utilizing ASTM D7175-15 was found to be on comparable range.

The above-discussed tests have demonstrated and established that the bitumen pellets or the bitumen pellet composition of the present invention is capable of meeting the objects of the present invention without change in its basic characteristics. Further, it as good as the existing bitumen or it is better while additionally the bitumen pellet composition provided herein provides convenience for storage and transport at normal temperature in a safe manner compared to bitumen which is currently transported in trucks at a temperature varying up to about 145° C.

As per the present experiments, in accordance with one of the exemplary embodiments of the present invention, the presently provided bitumen pellets or bitumen pellet composition is suitable for storage and transportation during all possible weather, hence it is suitable for construction of road and/or highway in cold and hot regions, and in wet and dry regions. Furthermore, in accordance with one of the exemplary embodiments of the present invention, the presently provided bitumen pellets or bitumen pellet composition is suitable for storage and transportation, and for construction of road and/or highway for a temperature of about 10° C. and higher, preferably for a temperature varying from about 10° C. to about 40° C. It may be noted that the presently provided bitumen pellets or bitumen pellet composition may be made suitable for storage and transportation, and for construction of road and/or highway even at a temperature higher than about 40° C. by providing a provision for heating.

The above-discussed surprising and unexpected technical advantages of the presently provided bitumen pellet composition have been demonstrated and established by the forgoing experiments.

Therefore, the presently provided bitumen pellet composition has been found to be synergistic in nature demonstrating its surprising and unexpected technical advantages as discussed herein above.

As can be observed from the foregoing, the bitumen pellet composition of the present invention is an innovative product that has the potential to revolutionize the way bitumen is stored, transported and used for road laying purposes thereby delivering huge economic benefits to road projects and profits to potential investors, that is, it is A Game Changer.

1. A bitumen pellet composition, wherein the composition essentially consists of:
bitumen combined with:
a) polyvinyl alcohol (PVA);
b) polyvinyl acetate (PVAc); and
c) anti-agglomeration agent (AAA);
wherein the anti-agglomeration agent (AAA) is essentially a fumed silica, wherein the fumed silica is essentially hydrophilic fumed silica.

2. The bitumen pellet composition as claimed in claim 1, wherein the bitumen is taken in an amount varying from about 91% to about 98% by wt. relative to the total weight of said bitumen pellet composition.

3. The bitumen pellet composition as claimed in claim 1, wherein the polyvinyl alcohol (PVA) is taken in an amount varying up to about 2% by wt. relative to the total weight of said bitumen pellet composition.

4. The bitumen pellet composition as claimed in claim 1, wherein the polyvinyl acetate (PVAc) is taken in an amount varying up to about 5% by wt. relative to the total weight of said bitumen pellet composition.

5. The bitumen pellet composition as claimed in claim 1, wherein the anti-agglomeration agent (AAA) is taken in an amount varying up to about 2% by wt. relative to the total weight of said bitumen pellet composition.

6. The bitumen pellet composition as claimed in claim 1, wherein the composition does not comprise tyre rubber, crumb rubber, or reclaimed tyre rubber.

7. The bitumen pellet composition as claimed in claim 1, wherein the composition does not comprise or uses lime or lime-based product(s) including limestone.

8. A method of preparation of the bitumen pellet composition as claimed in claim 1, wherein the method comprises the following steps:
a) a step of providing a layer or a coating of hydrophilic fumed silica over the bitumen;
b) a step of providing a layer or a coating of polyvinyl alcohol (PVA);
c) a step of drying the bitumen pellet coated with the hydrophilic fumed silica in step a), the polyvinyl alcohol (PVA) in step b);
d) a step of providing a layer or a coating of polyvinyl acetate (PVAc) on the coated bitumen pellet obtained in step c);
e) a step of drying the bitumen pellet as obtained in step d) after coating with the hydrophilic fumed silica in step a), the polyvinyl alcohol (PVA) in step b), and polyvinyl acetate (PVAc) in step d); and
f) a step of providing a thin layer or a coating of hydrophilic fumed silica over the bitumen pellet as obtained in step e); and
g) optionally a step of drying the bitumen pellet as obtained in step f).

9. A method of using the bitumen pellet composition as claimed in claim 1, for laying carpet on a surface including construction of road and highways.

10. A mixture comprising the bitumen pellet composition as claimed in claim 1.

11. The bitumen pellet composition as claimed in claim 1, wherein the bitumen is a base binder.

12. The method as claimed in claim 8, wherein the bitumen is a base binder, and wherein the bitumen is taken in an amount varying from about 91% to about 98% by wt. relative to the total weight of said bitumen pellet composition.

13. The method as claimed in claim 8, wherein the polyvinyl alcohol (PVA) is taken in an amount varying up to about 2% by wt. relative to the total weight of said bitumen pellet composition.

14. The method as claimed in claim 8, wherein the polyvinyl acetate (PVAc) is taken in an amount varying up to about 5% by wt. relative to the total weight of said bitumen pellet composition.

15. The method as claimed in claim 8, wherein the anti-agglomeration agent (AAA) is taken in an amount varying up to about 2% by wt. relative to the total weight of said bitumen pellet composition.

16. The method of using as claimed in claim 9, wherein the bitumen is a base binder, and wherein the bitumen is taken in an amount varying from about 91% to about 98% by wt. relative to the total weight of said bitumen pellet composition.

17. The method of using as claimed in claim 9, wherein the polyvinyl alcohol (PVA) is taken in an amount varying up to about 2% by wt. relative to the total weight of said bitumen pellet composition.

18. The method of using as claimed in claim 9, wherein the polyvinyl acetate (PVAc) is taken in an amount varying up to about 5% by wt. relative to the total weight of said bitumen pellet composition.

19. The method of using as claimed in claim 9, wherein the anti-agglomeration agent (AAA) is taken in an amount varying up to about 2% by wt. relative to the total weight of said bitumen pellet composition.
